(19) United States
(12) Patent Application Publication
(10) Pub. No.: US 2002/0062346 A1
(43) Pub. Date: May 23, 2002

(54) Apparatus, method, and computer program to integrate applications and appliances over a network

(76) Inventor: Joesph Shih-Chun Chen, Rowland Heights, CA (US)

Correspondence Address: Joesph Shih-Chun Chen, Xyphius Convergence Solutions, Inc., 18829 Elmhurst Avenue, Rowland Heights, CA, 91748, US

(21) Appl. No.: 09/962,044

(22) Filed: Sep. 21, 2001

Related U.S. Application Data
(60) Provisional application No. 60/234,730, filed on Sep. 22, 2000.

(51) Int. Cl. G06F 15/16; G06F 9/00

(52) U.S. Cl. 709/204

(57) ABSTRACT

An apparatus, method, and computer program are provided which allows service requesters to receive services from a single provider which can efficiently coordinate and cause the delivery of a requested service through a network, e.g. the Internet. Further the service is provided without compatibility obstacles and in which the requester can also use their preferred service providers. A request for service is made through the network to an application server which determines, from among a plurality of registered functional entities with the application server, which functional entity to route the request to. The functional entity may be an on-line or an off-line functional entity, i.e., an on-line or an off-line business. The functional entity produces output that is transmitted, either through the network or physical delivery, back to the requester and/or the application server. The application server can also use functional entities to transform incompatible data to requester, compatible data.

The present application claims priority to U.S. Provisional Application of Chen, filed Sep. 22, 2000, Ser. No. 60/234,730, the entirety of which is hereby incorporated into the present application by reference.

### COPYRIGHT NOTICE

This patent document contains information subject to copyright protection. The copyright owner has no objection to the facsimile reproduction by anyone of the patent document or the patent, as it appears in the U.S. Patent and Trademark Office files or records but otherwise reserves all copyright rights whatsoever.

### FIELD OF THE INVENTION

The present invention generally relates to providing functional services to end users over a network.

### BACKGROUND OF THE INVENTION

On-line services provided to end users typically involve an end user directly requesting a service from the provider. For example, if the end user desires airline tickets, he/she selects a service provider to use (typically, a favorite service provider) and requests the tickets by retrieving a service provider's web page, entering the appropriate information, sending the information to the service provider's computer, receiving information back from the provider's computer regarding price, etc. The end user then purchases the tickets by, typically, entering credit card information and sending it to the service provider. If the user then wants, for example, a local map of the city to which he/she is traveling, the user typically then retrieves his/her favorite service provider's web page for this function, enters more information, and receives the map output information from the service provider for downloading/printing.

Attempting to provide convenience to users, some service providers, e.g. content providers, offer several different services. For example, a content provider may provide service such as instant message, notification/reminder, calendar, stock quotes/trade, etc. However, these content providers do not allow the user to select their favorite service providers for each function, and the output provided by the content provider is typically incompatible with the user's already established interface with their favorite provider. Thus, for the content provider's services to be useful, the end user would have to switch his/her software to be compatible with the content provider's output. As a result, many users typically resort to their established approach and use their individual favorite sites separately.

### SUMMARY OF THE INVENTION

There is a need to provide an apparatus and method which allows service requesters to request an array of services from a single service provider which can efficiently coordinate and cause the delivery of a requested service.

Accordingly, the present invention is provides an apparatus that may include a first computer configured to communicate through a network with a second computer including a transmitting portion and a receiving portion, the first computer comprising a receiving portion, a storage portion, a processing portion, and a transmitting portion, the receiving portion to receive first information from the transmitting portion of the second computer, the transmitting portion of the first computer being configured to transmit the first information to a functional entity based upon the first information, the functional entity configured to communicate with at least one of the first computer and the second computer, the functional entity comprising a receiver to receive the first information from the first computer, the functional entity to produce output based upon the first information and send the output to a recipient.

### BRIEF DESCRIPTION OF THE DRAWINGS

The present invention is further described in the detailed description which follows, by reference to the noted drawings by way of non-limiting exemplary embodiments, in which like reference numerals represent similar parts throughout the several views of the drawings, and wherein:

FIG. 1 illustrates a system level view of an embodiment of the invention;

FIG. 2 illustrates a system level view of an embodiment of the invention;

FIG. 3 illustrates a detailed view of the first computer of FIG. 1;

FIG. 4 illustrates a detailed view of the second computer 104 of FIG. 1;

FIG. 5 illustrates a detailed view of the second computer 104 of FIG. 1;

FIG. 6 illustrates a detailed view of the fourth computer 202 of FIG. 2;

FIG. 7 illustrates a detailed system level view of an embodiment of the invention;

FIG. 7b is a more detailed illustration of FIG. 7;

FIG. 8 illustrates a sample web page produced by the first computer of an embodiment of the invention;

FIG. 9 illustrates another sample web page produced by the first computer in FIG. 7;

FIG. 10 illustrates an authentication image on the web page produced by the first computer in FIG. 7;

FIG. 11 illustrates another sample web page produced by the first computer in FIG. 7;

FIG. 12 illustrates another sample web page produced by the first computer in FIG. 7;

FIG. 13 illustrates another sample web page produced by the first computer in FIG. 7;

FIG. 14 illustrates an example of an embodiment of the present invention;

FIG. 15 illustrates an example of converting data from one data type to another data type;

FIG. 16 illustrates an example of serially converting data from one data type to another data type;

FIG. 17 illustrates another sample web page showing two human languages are displayed, the display produced by the first computer in FIG. 8;

FIG. 18 illustrates an example of 1-1-1 mapping according to an embodiment of the present invention;

FIG. 19 illustrates an example of 1-1-M mapping according to an embodiment of the present invention;

FIG. 20 illustrates an example of M-1-1 mapping according to an embodiment of the present invention;

FIG. 21 illustrates an example of M-1-M mapping according to an embodiment of the present invention;

FIG. 22 illustrates an example of M-M-M mapping according to an embodiment of the present invention; and

FIG. 23 illustrates a flowchart of several processing steps of the apparatus of an embodiment of the present invention.

### DETAILED DESCRIPTION

While the present invention will hereinafter be described in connection with at least one exemplary embodiment thereof, it should be understood that it is not intended to limit the invention to that embodiment. On the contrary, it is intended to cover all alternatives, modifications and equivalents as may be included within the spirit and scope of the invention as defined by the appended claims.

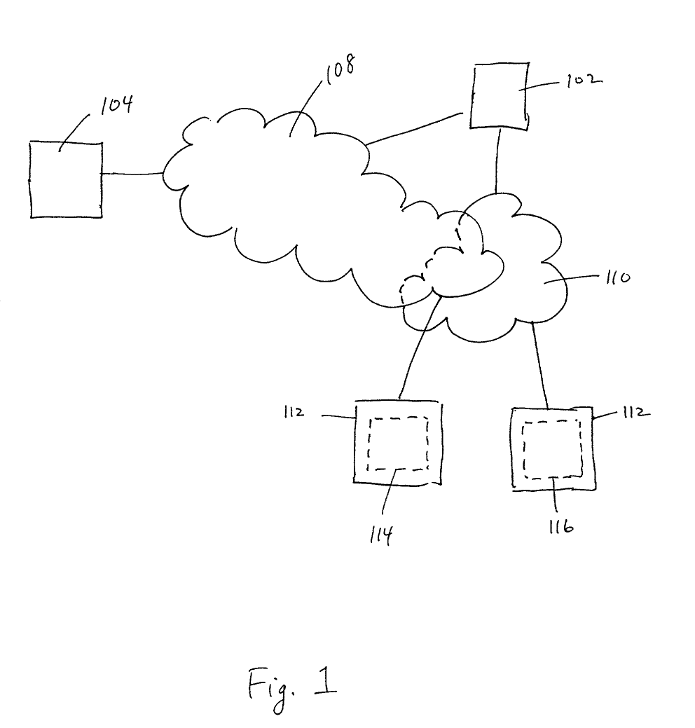

FIG. 1 illustrates an embodiment of the invention. A first computer 102 is configured to communicate through a network 108 with a second computer 104. The first computer 102 receives first information from the second computer 104, and based upon the first information, transmits the first information through a network 110 to a functional entity 112, the functional entity having a receiver to receive the first information. The functional entity 112 is to produce output based upon the first information and send the output to a recipient.

The networks 108 and 110 may be, for example, a network of interconnected networks, such as the Internet, an intranet, a local area network (LAN) and/or a wide area network (WAN). In the illustrated embodiment of FIG. 1, network 108 comprises the Internet. Network 110 may also be a public switched telephone network.

The first information may be a request to perform a given task. After receiving the first information via the network, the first computer processes the first information, and based upon the given task, transmits the first information to a functional entity. The functional entity to which the first information is sent is an entity capable of performing at least one task, and the at least one task includes the given task.

In an exemplary embodiment, the first computer 102 determines from among a plurality of functional entities a set of functional entities which can perform the given task. The processor of the first computer 102 is configured to then determine the functional entity 112 from the set, and transmits the first information to the determined functional entity. For example, the first information may be a request by the second computer 104 to purchase airline tickets. The first information would be transmitted to the first computer, which would then determine from among a plurality of functional entities a set of functional entities that can perform the task of purchasing airline tickets. The processor of the first computer would then determine which functional entity to utilize to perform the function. The criterion to determine which functional entity from the set to utilize will be discussed below. The functional entity to which the first information is sent may also be selected by the second computer 104, or a user of the second computer.

The functional entity 112 may be an on-line entity or an off-line entity. For example, in the case where the first information is a request to purchase airline tickets, functional entity 110 may be a third computer 114 configured to communicate through the network 108 with the first and second computers 102, 104 (i.e., both being on-line entities themselves), the function of the third computer 114, for example, being to search airlines and find fares, and to send this output to the recipient. The output from the third computer 114 is referred to as second information, the second information being a representation of a result of performing the given task. In such a case, the network 110 may be the same as network 108, as indicated by the overlapping portions of networks 110 and 108 (i.e., network 110 may be the Internet, intranet, LAN, or WAN). The recipient may be at least one of the first computer 102 and the second computer 104. That is, the second information may be transmitted to at least one of the first computer 102 and the second computer 104.

The functional entity 112 may also be referred to as a service provider 112. A service provider may be a business that can provide its applications, or application components on-line, or it can be an off-line business. The application may include software logic running in smart networked appliances and devices, such as wireless programmable digital assistants (PDA), JINI-enabled home appliances, and network appliances (i.e., web terminals).

The service provider 112 (i.e., functional entity 112) may also be an off-line entity 116 (i.e., an off-line business). For example, the first information may be a request by the user of the second computer 104 to have an item delivered to a physical address. The functional entity determined by the first computer to perform this function may not have an on-line service. Here, the first computer may transmit the first information to the off-line entity 116 via a public switched telephone network. The off-line entity may receive the first information in a receiving portion configured to receive information via the public switched telephone network, i.e., a telephone or facsimile machine, and based upon the first information, send the output to the recipient, where the output comprises the function to be performed based upon the first information. For example, the off-line company may receive a facsimile purchase order request for an item, to be delivered to a recipient. The off-line business may then physically deliver the requested item to the recipient, and the recipient may be a physical address.

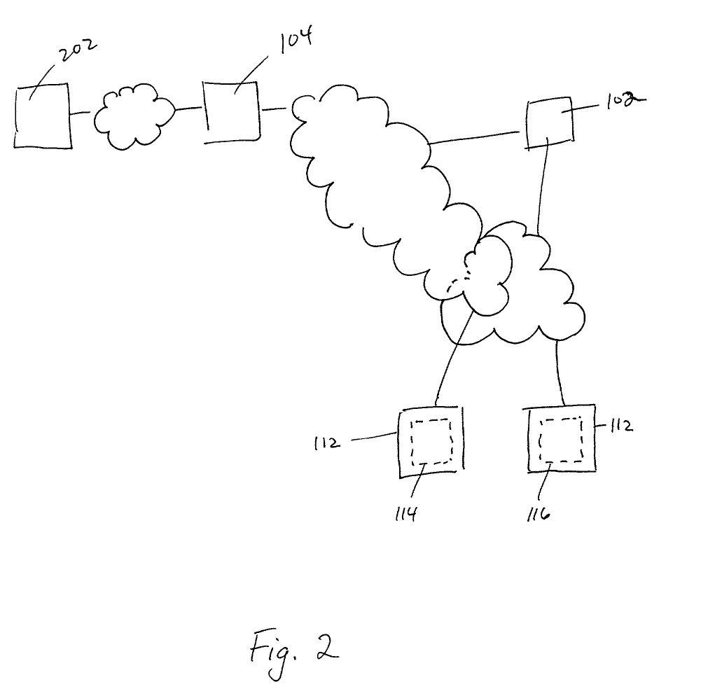

In another embodiment, the second computer 104 may receive the first information through the network 108 from a fourth computer 202, shown in FIG. 2. The fourth computer 202 is configured to communicate through the network 108 with the second computer 104, and may also be configured to communicate through the network 108 with the first and third computers as well. Where the functional entity is the third computer 114, the second information generated by the third computer 114 based upon the first information is transmitted through the network 108 to at least one of the first computer 102, second computer 104, and fourth computer 202. The fourth computer 202 may also be referred to as the end user.

In an exemplary embodiment, the third computer 114 transmits the second information directly to the fourth computer 202. Thus, the functional entity 112 (i.e. third computer 114) selected by the first computer 102 may be transparent to the second computer 104. That is, the second computer 104, which transmitted the first information to the first computer on behalf of the user of the fourth computer 202 may not be aware which functional entity (i.e., third computer 114 or off-line entity) provides the output (i.e., second information or service). The functional entity is also referred to as a service provider, and the second computer is also referred to as the service requester.

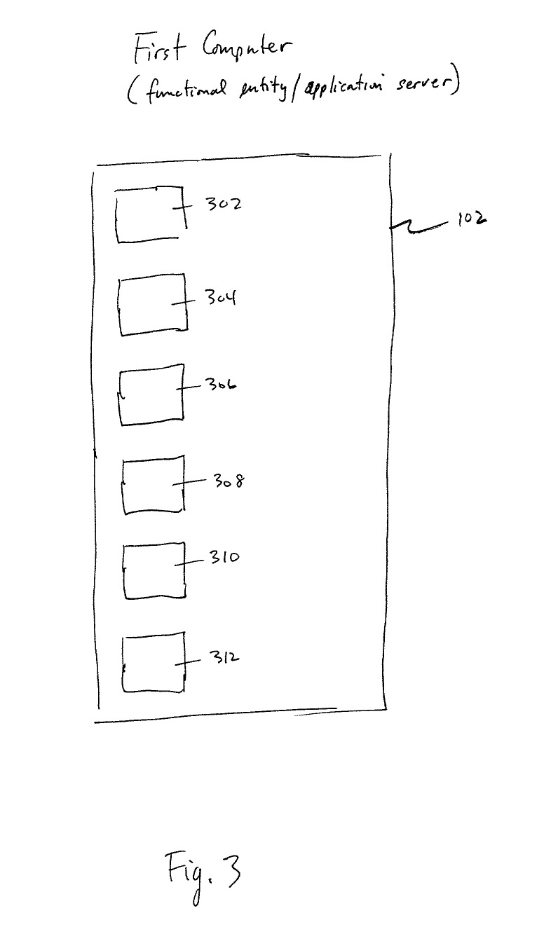

FIG. 3 illustrates a detailed view of the first computer 102. The first computer 102 may be referred to as the application server 102. The application server 102 includes a transmitting portion 302 to transmit first information and imaging information over the network 108, a receiving portion 304 to receive information from the network 108, a storage area 306, and a processing portion 308. The storage area 306 may be, for example, a random access computer memory and/or space on a disk in a hard drive. The storage area 306 may be encoded with the program which, when implemented by the processor 308, determines a functional entity 112 to transmit the first information. That is, the application server is configured to find available services (or functions), determine the service provider, map potentially incompatible input and output data, and route the first information to the service provider.

The application server 102 supports files in the form of hypertext markup language (HTML), Extended Markup Language (XML), and JAVA script commands, all of which are well known in the art. The network path to the application server 102 is identified by a Uniform Resource Locator (URL), as is well-known. The application server may also comprise a graphical user interface 310 (GUI) for management and administration.

The application server 102 may also comprise a presentation portion 312 to prepare at least one visual presentation display to send to at least one of the second computer 104 and the fourth computer 202. The display may include content to be displayed in at least one of a first human language and a second human language, with the content including a list of a plurality of functional entities. From this list, the user of the fourth computer 202 or the second computer 104 may select the functional entity to utilize, i.e., to send the first information to. The display may also be displayed in both the first and the second human languages simultaneously, with the human languages displayed being determined (i.e., chosen) by the user of at least one of the second computer 104 and the fourth computer 202. For example, the user of the fourth computer 202 can view the contents of the first computer's web page in two human languages simultaneously.

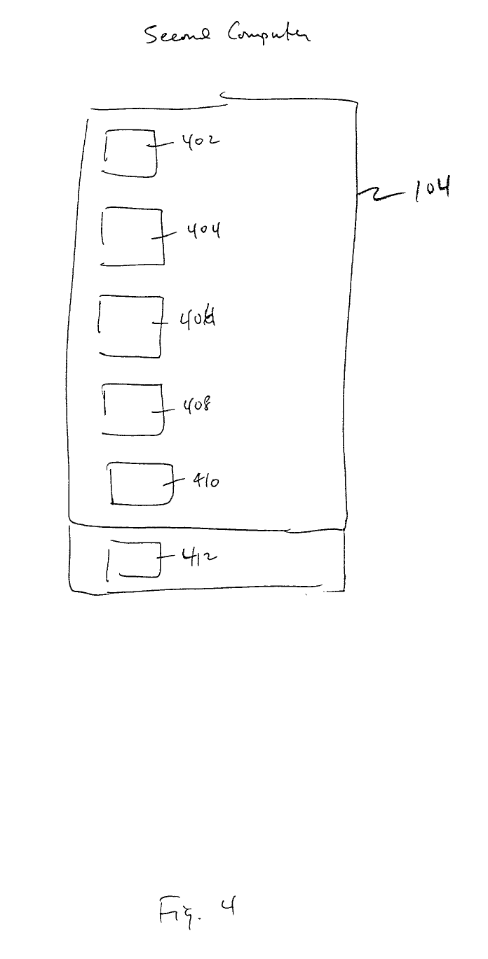

FIG. 4 illustrates a detailed view of the second computer 104. The second computer 104 may also be referred to as the service requester 104 (which may also be a server). The service requester 104 includes a transmitting portion 402 to transmit first information and imaging information over the network 108, a receiving portion 404 to receive information from the network 108, a storage area 406, and a processing portion 408. The storage area 406 may be, for example, a random access computer memory and/or space on a disk in a hard drive. The storage area 406 may be encoded with a program which, when implemented by the processor 308, may categorize the first information. The second computer 104 supports files in the form of hypertext markup language (HTML), Extended Markup Language (XML), and JAVA script commands, all of which are well known in the art. The network path to the second computer 104 is identified by a Uniform Resource Locator (URL), as is well-known. The second computer 104 may also comprise a graphical user interface 310 (GUI) for management and administration. The second computer 104 may be a content provider which, as mentioned above, receives the first information the user of the fourth computer 202.

The service requester 104 requests, via the first information, an application function from the application server 102 (i.e., first computer). The service requester 104 may be an entity of any type, such as an on-line content provider, or an individual. Its application, or software logic running in smart network appliances and devices can execute the requests.

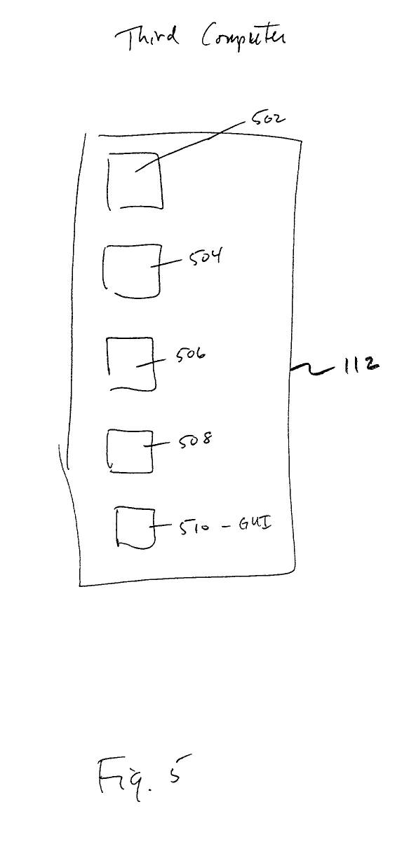

The service requester 104 may also be a service provider. Therefore, a service requester who is also a service provider can query the availability of other services, choose preferred service providers for the component function it needs, and request them, via first information, through the application server 102 (i.e., first computer).

Where the service provider (i.e., functional entity) is a third computer 114, the third computer 114 may be referred to as a third server 114. FIG. 5 illustrates a detailed view of the third server 114. The third server 114 includes a transmitting portion 502 to transmit information (including second information) and imaging information over the network 108, a receiving portion 504 to receive information (including first information) from the network 108, a storage area 506, and a processing portion 508. The storage area 506 may be, for example, a random access computer memory and/or space on a disk in a hard drive. The storage area 506 may be encoded with a program which, when implemented by the processor 508, performs a function based upon the first information and produces output, i.e., second information. The third computer 114 supports files in the form of hypertext markup language (HTML), Extended Markup Language (XML), and JAVA script commands. The network path to the third computer 114 is identified by a Uniform Resource Locator (URL). The third server 114 may also comprise a graphical user interface 510 (GUI) for management and administration.

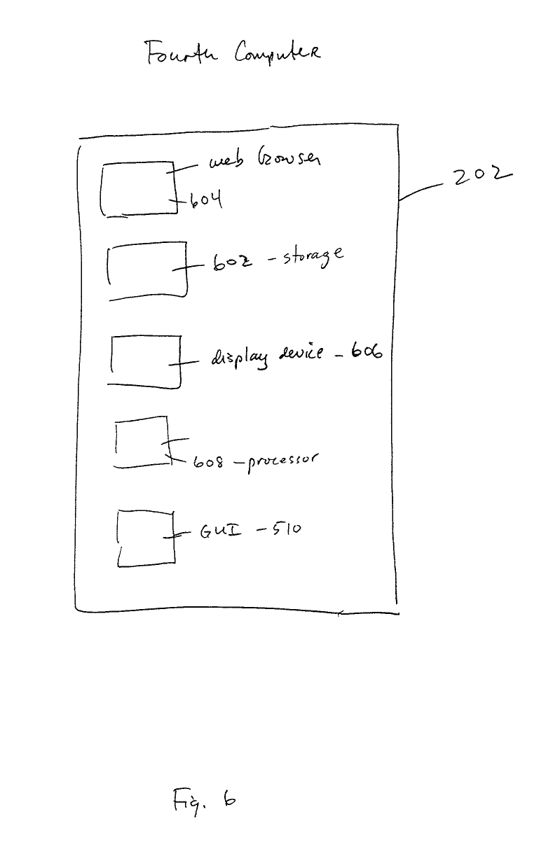

FIG. 6 illustrates a detailed view of the fourth computer 202 (i.e., end user). The fourth computer 202 includes storage 602 which may be, for example, a random access computer memory or storage space on a disk in a hard drive. The computer also includes a web browser 604. The web browser 604 displays data and is capable of communicating with other computers via a network, such as, for example, the Internet or an intranet. The web browser 604 provides a user with a way to navigate, via, for example, hyperlinks which are selected by a pointing device, such as a computer mouse, or are typed in by the user. The web browser uses a transfer protocol, for example, HyperText Transfer Protocol (HTTP) or File Transfer Protocol (FTP), to transmit data of various content, such as, for example, Hypertext Transfer Markup Language (HTML) documents, plain text documents, graphic images, and extensible Markup Language (XML) documents. The web browser 604 may also run programs such as, Java applets. The web browser 604 may be, for example, Internet Explorer® by Microsoft Corporation of Redmond, Wash., Netscape Navigator® by Netscape, or any other web browser. A display device 606 of the fourth computer 202 is used by the web browser 604 to present a display to a user. The display may be a presentation display prepared by the presentation portion of at least one of the first computer and second computer 104. The fourth computer 602 also comprises a processor 608 and a GUI 610.

The end user 202 can access services on from the application server 102 in two ways. First, the end user 202 can enter the application server's website. The end user 202 can request any service that may be available on the application server. Also, the end user 202 may set preferences for which service provider or providers as the default in each service category, therefore allowing service requesters to access the services without knowing provider the end user has selected. Second, as mentioned above, an end user 202 can access the application server 202 indirectly via other on-line websites and businesses who are service requesters, who can optionally enter the application server's website on behalf of the end user.

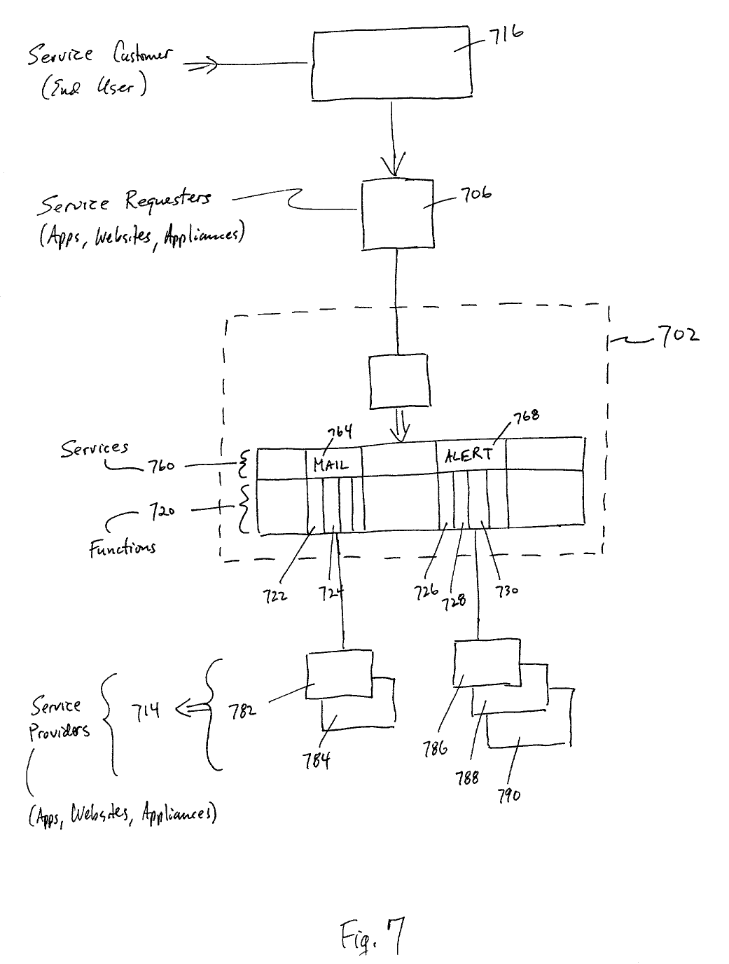

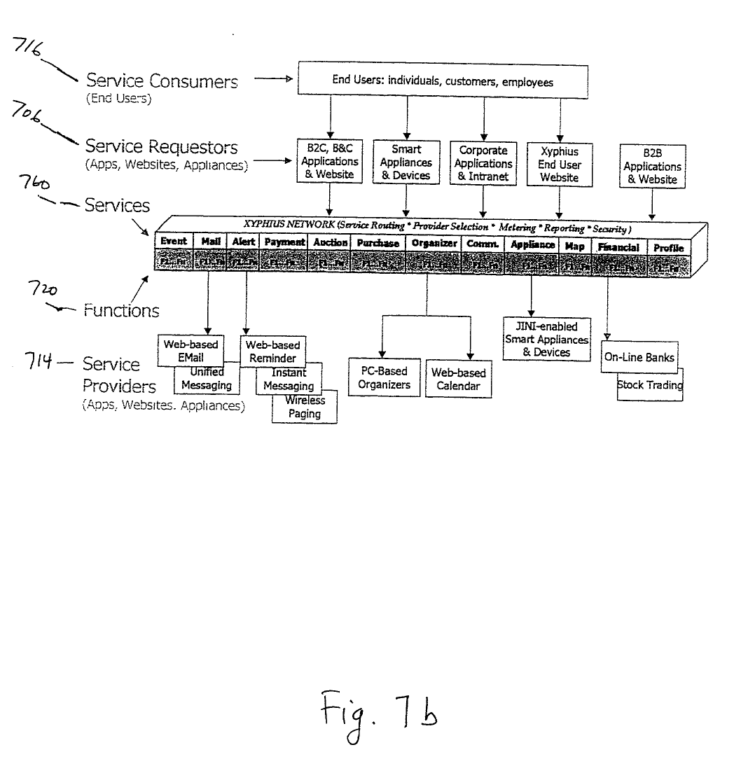

FIG. 7 is a detailed illustration of an embodiment of the present invention. The application server 702 represents the first computer 102 described above. Service requesters 706 represent a plurality of second computers 104. Service providers 714 represent a plurality of functional entities 112, either on-line entities (i.e., third computer 114) or off-line businesses 116. Each service provider can perform at least one application function, or task. Service consumers 716, which are also referred to as end users 716, represent the fourth computer 202. FIG. 7b is another depiction of FIG. 7,

Service providers 714 are registered with the application server 102 in order to become available to interested service requesters 706. Such registration is accomplished via the application server's website. The application server's website includes the ability of the service provider 714 to browse available services and functions. Once decided on a service to provide, the service provider 714 may input necessary information, including how to relate each of its functions to its implementation. This is accomplished by creating a functional connector.

A functional connector defines the relationship between a function and a provider providing implementation of the function. For each functional connector, the service provider 714 must specify how-to information, including protocol choice (HTTP Get Method, HTTP Post Method, CORBA, DCOM, JINI, RMI, SOAP, etc.), directory lookup, authentication pre-requisites (e.g., login and password requirement, digital signature), precise input parameters needed by the provider's implementation of the function, its output type (i.e., second information), and various other pre- and post-processing requirements, as generally known in the art.

Once registration of the service provider is complete, the provider's service is available, and is docked. There are two types of docking of the service provider: perennial and “just-in-time.” Perennial docking is where the service provider is available anytime. The application server 102 may assume that all URL-based services (i.e., on-line services) are docked by default. If the website is unavailable to handle the request of the first information, a standard error may be reported. Just-in-time access mostly applies to smart appliances that may not be on the network 108 or 110 continuously. For example, wireless programmable digital assistant (PDA), a JINI-enabled device including a printer, video camera, and home appliances like SPA, VCR, or washer. The docking of such services is only possible when the device is turned on.

Service providers 714 may also play the role of service requesters 706, for example, to complete its workflow. That is, to complete its function, it may request the function of another service provider 714 and therefore transmit first information to the application server 702.

The service requesters 706 may connect to the application server 102 via one of a technology-specific toolkit, which the requester can access on the application server. The toolkit includes Application Programming Interfaces (API's) that allow the requester to do at least one of the following: authenticate itself as a member and connect to the application server 102; optionally login on behalf of its end user who is also a member of the application server; explore available services or functions for itself, or for its end user; request service or function via first information for itself, or for its end user; modify preferences for itself or for its end user (including security related preferences); request metering and billing information for itself, or for its end user; request a journal for all activities for itself, or for its end user. The toolkit is available for a variety of application development platforms, including but not limited to Java, C++/Unix, C++/Microsoft.

The application server 702 in the embodiment of FIG. 7 shows a plurality of application functions 720 for services 760 that have been registered by the service providers 714. For example, mail service 764 is shown as being registered by service provider (i.e., functional entity) 782, which can perform, for example, a web-based email function 722. Service provider 784 is also registered with the application server 702 to perform mail service 764, but using, for example, a unified messaging function 724. Another service shown in FIG. 7 is an alert service 768. Application functions 726, 728, 730 are shown registered functions by service providers 786, 788, and 790, respectively. For example, service provider 786 may perform a web-based reminder fimctions 726; service provider 788 may perform an instant messaging function 728; and service provider 786 may perform a wireless paging function 730.

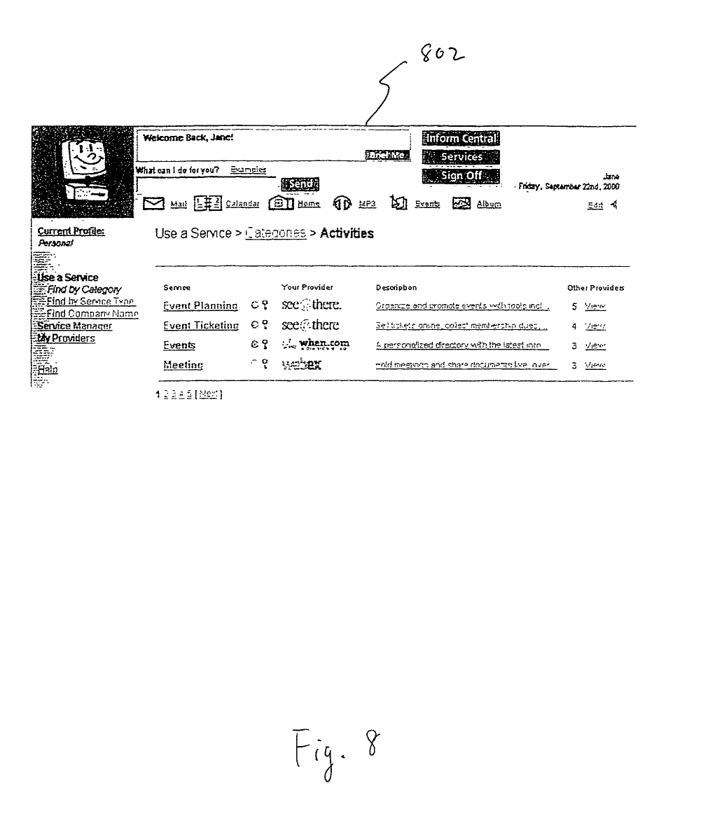

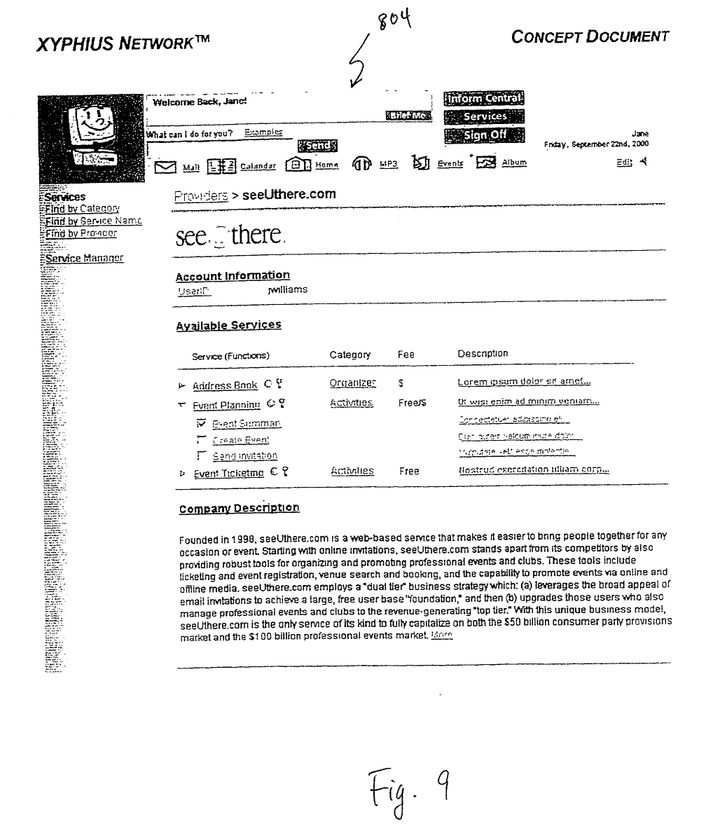

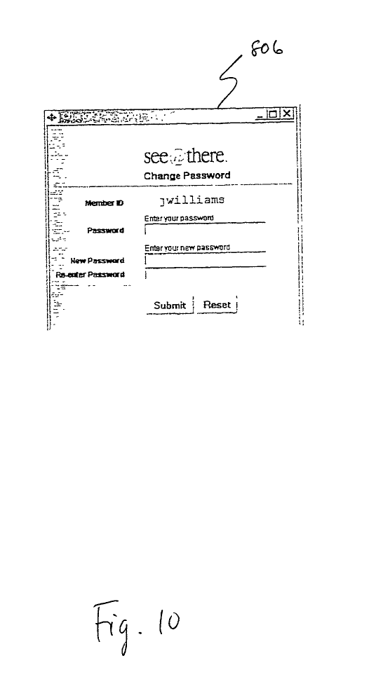

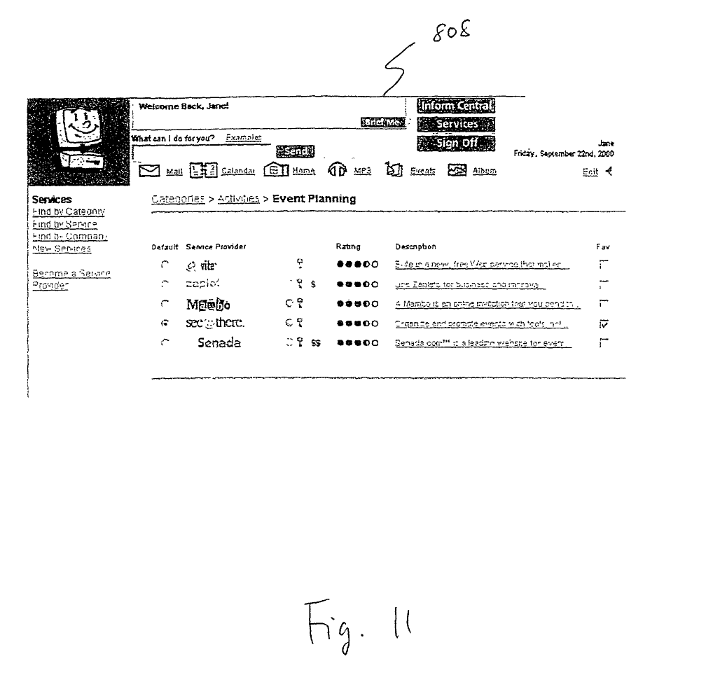

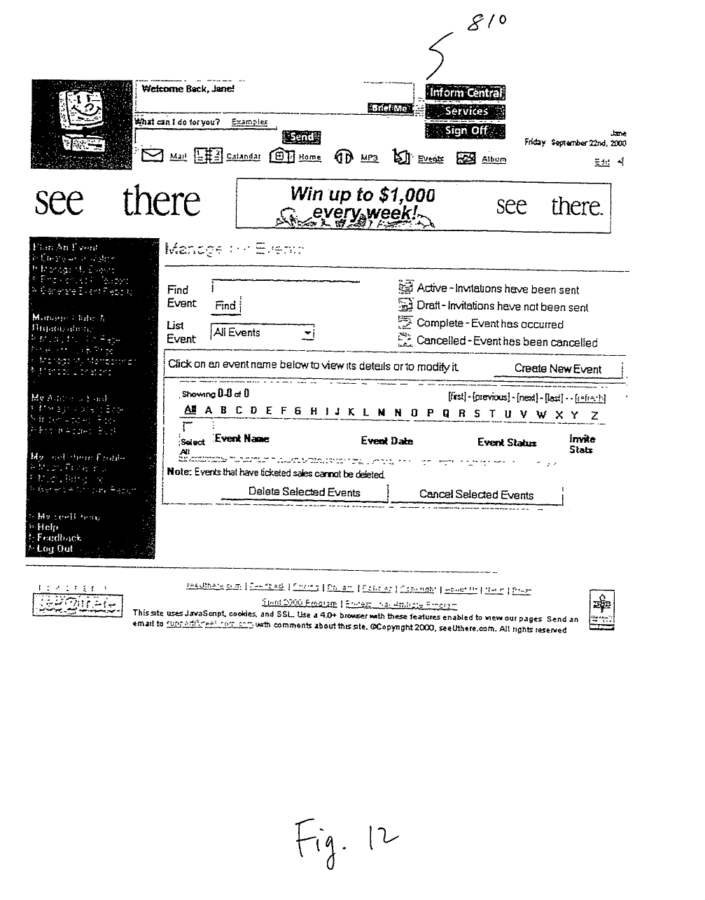

As mentioned earlier, the end user 716 may gain access to the application server 702 directly via the application server's own end user website, or the service requester 706 can make a request via first information to the application server on behalf of the end user. FIG. 8 shows an example of the application server's website 802. Where the end user 716 gains access directly onto the application server's website, the end user may browse a catalog of services and functions and select them directly. For each service, the end user may explore the details of each service provider providing that service. FIG. 9 illustrates another web page 804 with the end user exploring the service provider “SeeUthere” under the service “Event Planning.” For each service, the website may identify each service provider that the user has access to and specify access information, including user name and password. In FIG. 9, the user has access to SeeUthere, and can proceed in modifying the authentication information, as shown in the pop-up image 806 of FIG. 10. For each service, the end user can explore other service providers competing in providing the same service, and the end user can evaluate each service provider based on other peoples' opinions and ratings, shown in the web page 808 illustrated in FIG. 11. The end user may also request a service, even where a default service provider may have been previously set by the application server 702. For example, in the pop-up image 806 illustrated in FIG. 10, the requested service “Event Planning” is invoked, and the end user's preferred service provider in this case is SeeUthere.com. The application server 702 returns web page 810, shown in FIG. 12. The web pages are returned by the application server 702 in, for example, HTML, because the function is web-based and its user interface is in, for example, HTML. The web pages can be in any other markup language known in the art, such as XML, SGML, etc.

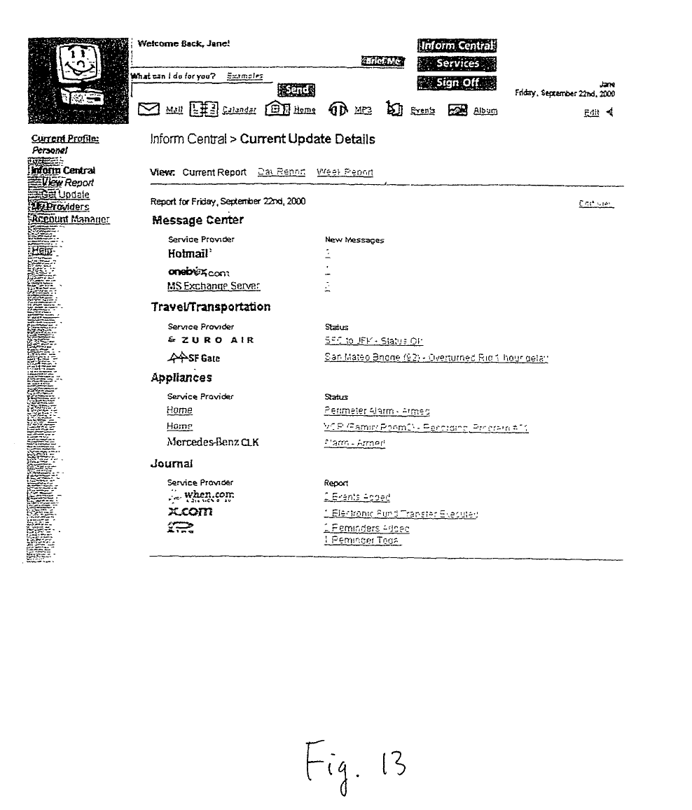

The application server 702 may also request a summary from each service provider used by the end user 716. The request may be on a standard summary function, in which the application server informs each service provider, for example, that the end user has not logged onto the system for a number of hours, and each service provider may determine what kind of information is best to inform the end user given the duration. On the application server's end user website, this feature is called the “Inform Central” and is illustrated in the web page of FIG. 13. The end user may also update its personal profile with other preferences, including a selection of languages by which to display the website.

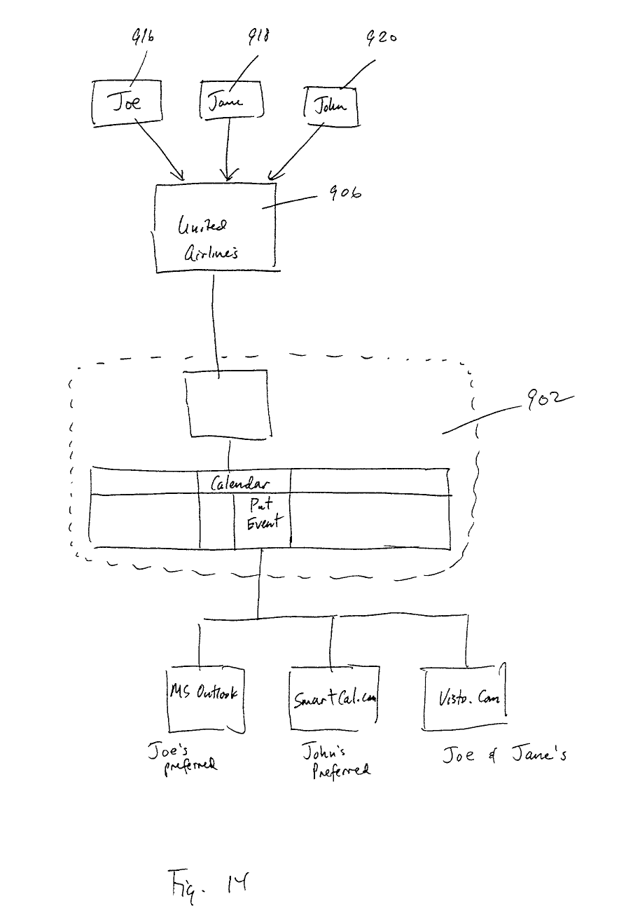

If the end user 916 makes a request via first information to a service requester 906, the service requester may not be aware which service provider is actually invoked by the application server 902. For example, as illustrated in FIG. 14, if the airline (service requester 906) is placing a travel itinerary on end user's 918 calendar, the application server, after receiving the request through the network 108 from the service requester 906, will route the request the service provider Visto.com, Jane's calendar of choice. If the airline customer is Joe 916 (the end user), then both of his calendars in MS Outlook running on his PC and managed by Visto.com will be updated, since both MS Outlook and Visto.com are his preferred providers. In all cases, the airline, as a service requester 906 requesting the “Put Event” function, is not aware of the actual calendar service provider selected by its end user because the application server 902 transparently routes the request to the appropriate service provider. Additionally, the service provider may transmit the output (i.e., second information) to either the application server 902, who then may transmit the output to the end user, or directly to the end user 916, 918, 920. In all cases, the output need not be transmitted to the service requester 906.

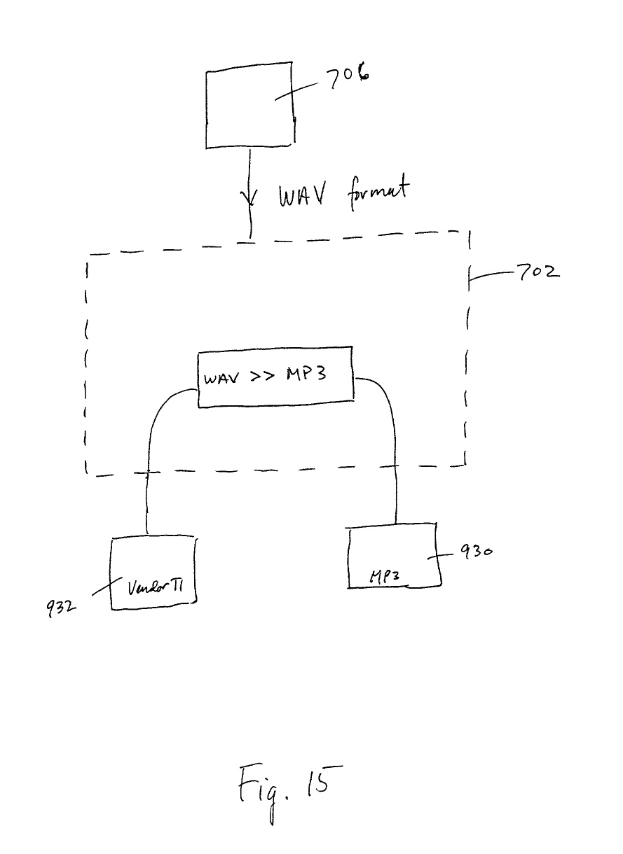

If the service requester requests a service from a service provider that only performs its function in a particular format that is incompatible with the format of the first information of the service requester, the application server 702 is configured to cause the first information to be converted into an other form that is compatible with the requested service provider. That is, the application server 702 (i.e., first computer 102) is configured to find ways for the two parties to interface. This is accomplished by the application server 702 by leveraging third party service providers who can provide specialized functional entities, referred to as transformation functions. For example, referring to FIG. 15, a function “play music” provided by an audio application service provider 930 can take only MP3 format as the input (i.e., first information). The service requester, however, may transmit another information format to the application server 702, such as WAV, SND, AIF, or other audio formats known in the art. In such a case, the application server 702 utilizes another transformation function (i.e., service provider or functional entity) to transform the WAV format into the MP3 format, and then the application server 702 transmits this transformed format to service provider 930. Such a specialized functional entity 932, for example, is therefore configured to convert the first information comprising a first form into an other form, the other form to be transmitted through the network 108 to the application server 702 (i.e., first computer 102). The specialized entity may be computer (i.e., a server).

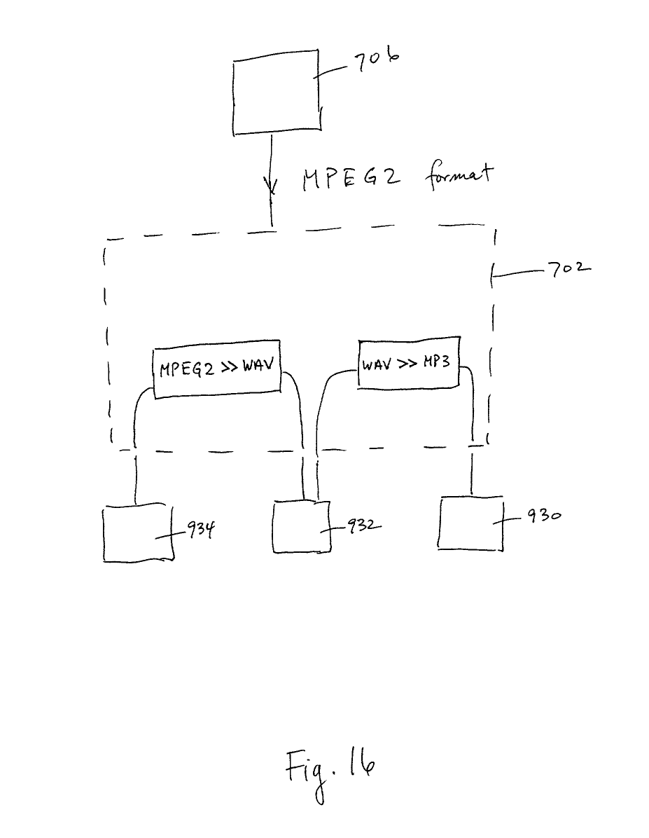

If there is no single functional entity that can convert the source format to the destination format (i.e., a transformation function), the application server 702 may serially connect server such service providers to complete the transformation. For example, referring to FIG. 16, the service requester transmits MPEG2 video format (i.e., first information) to the application server 702, requesting the service provider 930 to play the audio portion of the video, but the provider 930 only plays MP3 format audio. Therefore, the application server 702 transmits the first information to another service provider 934 that converts the MPEG2 format into the WAV format, and is transmitted back to the application server 702. The WAV format information is transmitted to service provider 932, which converts the WAV format information into MP3 information and transmits this MP3 format information to the application server 702. The application server 702 then transmits the MP3 format information to service provider 930, which can than play the audio portion of the video, as requested by the service requester 706.

The transformation functions may transform information from a concrete type format as input, to another concrete type as output. Concrete type format is a type that is directly associated with a physical piece of information or object. For example, WAV and SND (audio formats on a PC) and AIF (audio format on the Macintosh) are concrete types that relate to the abstract type of “Audio.” Internet Engineering Task Force (IETF), “vcard” and “vCalendar” data formats are concrete types that relate to the abstract types “Contact” and “Event.” Another type of data, known as “Data Type”, is the precise definition of data format, and is used to specify how concrete type is implemented. Some examples of Data Type include: 8-bit signed integer, 1 byte ASCII character, multi-byte character, 128-bit real number, byte Boolean, etc. Each technology such as Java, C++, CORBA, DCOM, HTTP, etc., all require proper conversion, which is done by the appropriate toolkit supplied by the application server 702 (or the first computer 102) to the service providers. It is contemplated that the transformation functions can convert other forms (or types) of information other than concrete types as well.

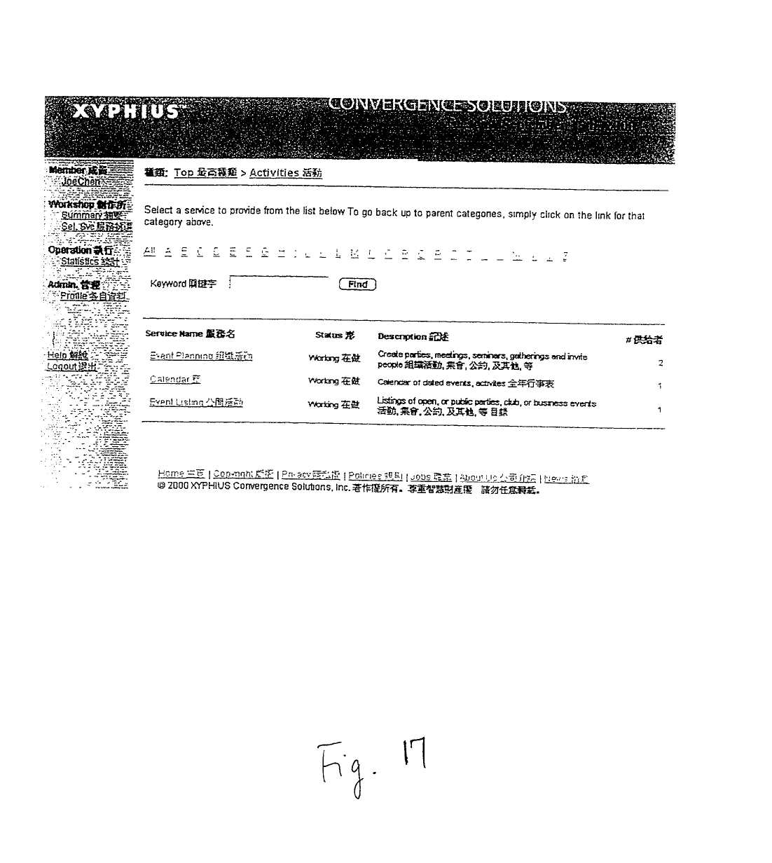

As describe earlier, the first computer 102 (i.e., application server 702) may provide an option to display two human languages, for example, side-by-side for its user interface, as well as for the service providers enabling to the application server 702, as shown in FIG. 17. The language preference of the first and second language may be changeable by the user. The dual language capability may be for static user interface text, and dynamic user requested data. In the case of data input, options may be offered to end users to enter the data in different human languages. The layout of FIG. 17 is shown as merely an example, and is not intended to be limiting.

Referring again FIG. 7, when a service requester or end user requests a service or function via first information, it becomes a request to invoke a function that is registered on the application server 702 (i.e., first computer). Each function has zero or more service providers that are capable of providing the function. Therefore, after receiving the request via the first information from the service requester 706, the application server 702 is configured to determine a service provider 714 (i.e., functional entity) based upon the first information. That is, the application server 702 determines the preferred or suitable service provider. Where the requester's input must be converted to the service provider's input, the application server 702 computes all paths necessary to make the transformation, each path corresponding to a transformation function that can convert a first information form to an other information form. The algorithm of the application server 702 comprises the steps of determining which provider to choose, preparing inputs, invoking the provider's function, and preparing outputs. The details of each step will now be described.

When an end user or service requester requests a function (e.g., play music or show address book) on the application server 702, the application server first determines which provider to choose. The end user may have his/her preferred service provider, and the service requester may have a preference in its profile of the end user. The application server 702 also has a preferred service provider. The requester may also specify a service provider explicitly. An algorithm in the application server 702 contains numerous preference data for choosing a service provider. The algorithm is as follows in pseudo code:

If ((SelectionPref = default) | | (SelectionPref = user)) {

First try end user's preference
If none, try requester's directly supplied function
If none, try requester's preferred provider
If none, try system preferred provider

} else if (SelectionPref = requesterFunction) {

first try requester's directly supplied function
If none, try requester's preferred provider
If none, try end user's preferred provider
If none, try system preferred provider

} else if (SelectionPref = requester) {

first try requester's preferred provider
If none, try requester's directly selected function
If none, try end user's preferred provider
If none, try system preferred provider

} else if (SelectionPref = system) {

first try system preferred provider
If none, try end user's preferred provider
If none, try requester's directly supplied function
If none, try requester's preferred provider

4}

The algorithm includes multiple tries because not every user has selected a preferred provider for every single service/function. The system may always have a default to ensure no service/function goes unsupported.

Once the appropriate provider function has been determined, the next step for the application server 702 is to transform input data type from one form into an other form compatible with the service provider expected to perform the function. This step may be referred to as interface mapping. The mapping is a process of taking all requester inputs, and provider's function inputs, and to select transformation paths that, once executed, will result in the precise data needed by the provider's function. A transformation path includes zero or more transformation functions. When executed orderly and serially, the output of the last transformation function results in the concrete type desired.

There are several variations to the mapping. Each variation is identified below, in order of complexity. The number is a triplet in cardinality (which is represented with either a 1 or an M (Many), comprising of number of requester's input, number of abstract inputs, and the number of parameters expecting from the service provider's function, respectively: a) 1-1-1 (one requester input mapped to an abstract type input, to one provider function input); b) 1-1-M (one requester input mapped to an abstract type input, to many provider function inputs); c) M-1-1 (many requester input mapped to an abstract type input, to one provider function input); d) M-1-M (many requester input mapped to an abstract type input, to one provider function input); and e) M-M-M (many requester input mapped to many abstract type inputs, to many provider function inputs).

To illustrate each of the above variations, a “Map Service” will be used as an example. The Map Service has a “Lookup” function. The function's interface has a single input parameter with an abstract type of “X.location.” An end user can be accessing his/her favorite website (service requester) and enter the location information from there, or alternatively, from a handheld wireless GPS device, which has software (service requester) that can connect to the application server 702.

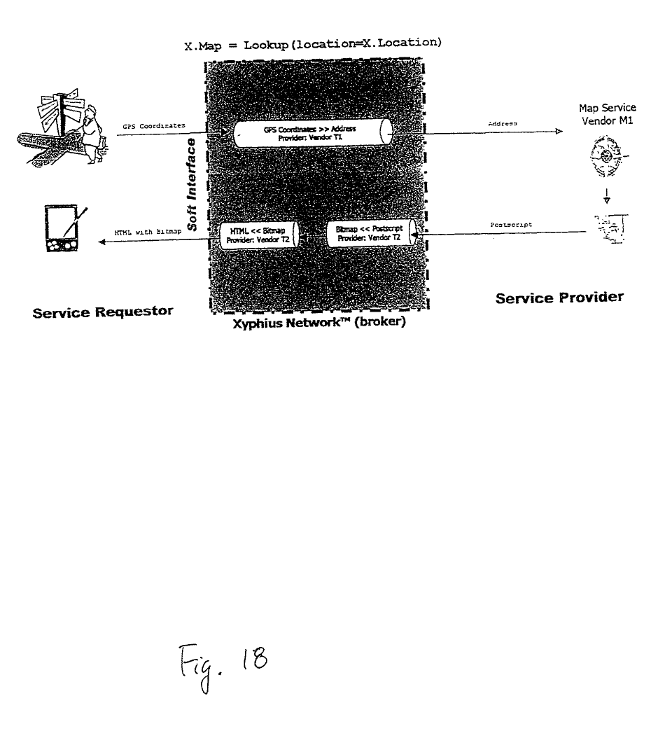

In the 1-1-1 scenario, a single provider of the Map Service takes data with the concrete type of “Address.” FIG. 18 illustrates a requester's input mapped to one function's input, to one provider function input. Here, the requester/end-user provides an input having a GPS coordinate (as a concrete type). The application server 702 determines the provider's function to use, and then prepares the input by mapping the GPS coordinate to a physical address using a transformation function (shown as Vendor T1). The output of the transformation function (the physical address) is provided to the service provider providing the map function (shown as MAP Service Vendor M1). A map is then generated in, for example, postscript and translated to, for example, bitmap and then to, for example, HTML as specified by the requester/end user.

The requester has a single data structure that can hold the coordinates from the GPS. This single parameter is mapped to the only input parameter defined by the application server 702 by the label name, “location.” The Map Service provider, “Vendor M1,” takes a single data structure containing the address. This could be an XML representation of an address, for example. In this scenario, it was assumed that the transformation functions exist and has at least one provider for each of the transformation functions.

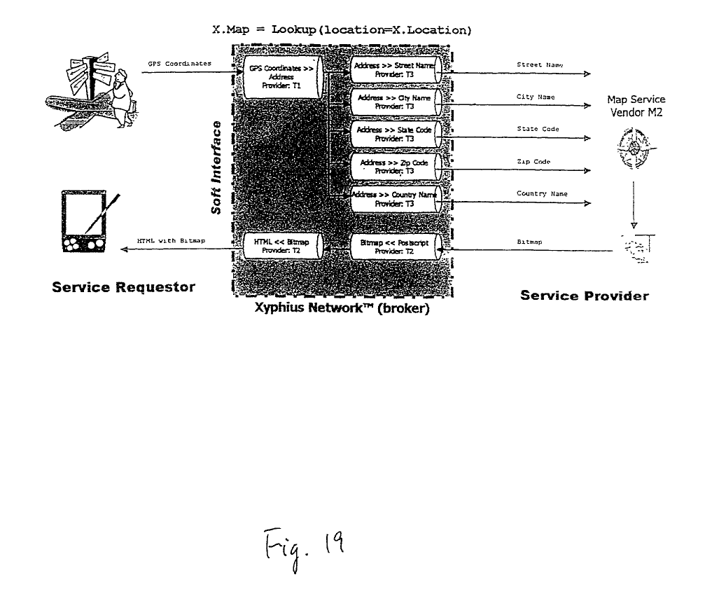

Referring now to FIG. 19, the requester's preference is another Map Service provider, “Vendor M2.” This service provider requires, for example, inputs separately for each of the street, city, state, zip code, and country. The transformation algorithm handles this scenario as follows. The requester/end-user provides input having a GPS coordinate (as a concrete type). The application server 702 determines the provider's function to use, and then prepares the input by mapping the GPS coordinate to a physical address using a transformation function and the one physical address is transformed to the elements of the physical address (i.e., street name, city name, state code, country name, zip code, etc.) and generated as output. The output of the transformation function (the elements of the physical address) are then provided to the service provider providing the map function (shown as MAP Service Vendor M2). A map is then generated in, for example, postscript and translated to, for example, bitmap and then to, for example, HTML as specified by the requester/end user.

The above task is accomplished as long as each of the input parameters needed by Vendor MS is associated with the application server's input label “location.” The application server's 702 transformation algorithm is able to find transformation paths to cover all inputs need by “Vendor M2.” The pseudo code below illustrates the mapping logic:

// “provider input type” defined as the input data types
// needed by the MAP Service Vendor M2;
//
For (j = each provider input type) {
// Loop through all the types

Path = findTransformationPath(requesterInput, j);

// Here there is only one requester input
// path is not empty if requester's input can be transformed
// to “provider input type”; it can be a list of zero or more transformation function
// that can be executed serially;

if (path ! = null)

provider input parameter = transform(requesterInput, path);

}
// provider input parameter is the actual data for MAP Service
// Vendor M2 and equals to the transformation of the
// requester's input using the path;

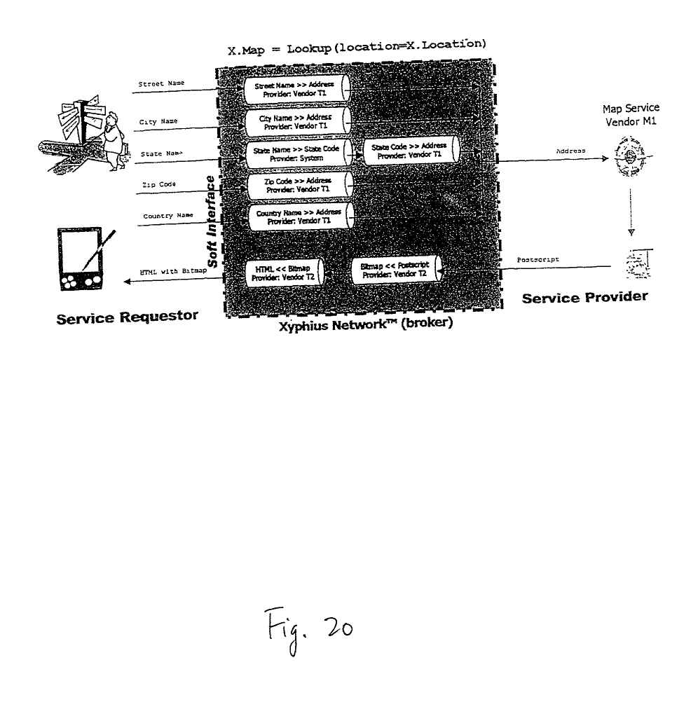

In the M-1-1 scenario, the requester has many inputs to one input defined for the application server 702, and exactly one input to the service provider's function. FIG. 20 illustrates this scenario. Here, the requester/end user provides input having a GPS coordinate (as a concrete type). All of these elements are associated with a single application server input label. The application server 702 determines the provider's functions (Map Service Vendor M1) to use, and then prepares the input by mapping the elements of the physical address (i.e., street name, city name, state code, country name, zip code, etc.) using a number of transformation functions to generate one address as output. The output of the transformation functions (the one physical address) is then provided to the service provider providing the map function (shown as MAP Service Vendor M1). A map is then generated in, for example, postscript and translated to, for example, bitmap and then to, for example, HTML as specified by the requester/end user.

The requester can only provide the address information with five distinct inputs: street, city, state, zip code, and country. All of these are associated with a single application server input, “location,” which has the abstract type “X.Location.” The Map Service provider, Vendor M1, takes exactly one input, a concrete type “Address.” The following pseudo code illustrates the mapping logic:

For (i = each requester input) {

Path = findTransformationPath(i.getType(), providerType);

// for each requester input, a path is found to transform the
// requester input data type to an element within
// the provider input data type

if (path ! = null)

provider input.add(transform(i, path));

// provider input is then generated from the requester's input
}

Since the provider input is a composite concrete object (Address), where each field may contain a transformed value from the requester, it must be constructed incrementally.

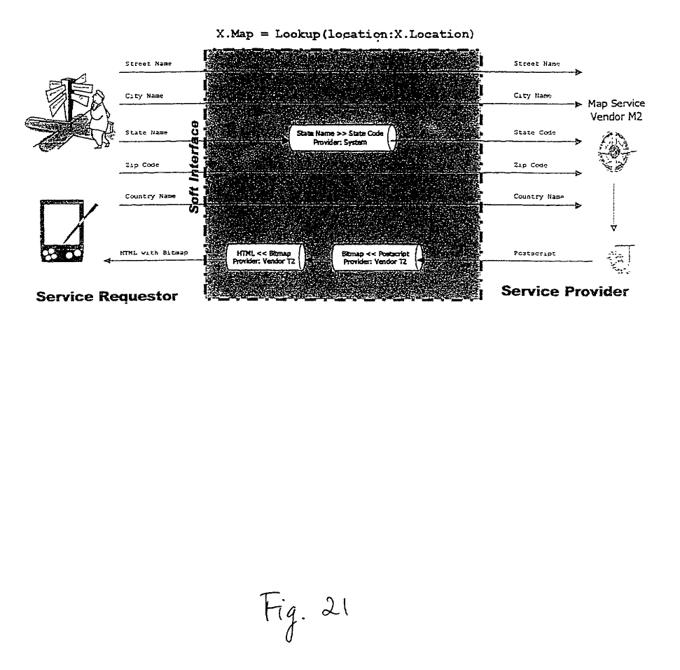

In the M-1-M scenario, for one conceptual input type, there are multiple inputs from the requester at the same time multiple inputs are needed by the service provider's function. FIG. 21 illustrates this scenario. Here, the requester/end user provides all of the elements of the physical address (as concrete type). All of these elements are associated with a single application server input label. The application server 702 determines the provider's functions (Map Service Vendor M2) to use, and then prepares the input by mapping the elements of the physical address using a single transformation function to convert state name to state code as the output. The output of the transformation functions (the one state code) and all other inputs (straight pass-throughs) are then provided to the service provider providing the map function (shown as MAP Service Vendor M2). A map is then generated in, for example, postscript and translated to, for example, bitmap and then to, for example, HTML as specified by the requester/end user.

The requester has the location in the form of street name, city name, full state name, zip code, and country name. The Map service provider, Vendor M2, is expecting the same number of inputs, except that is expecting a 2-letter state code. The multiple input specifications must associate with the signal input of the application server 702. The association is via the input label, which is with the single input of the application server 702. The association is via the input label, which is “location.” In this case, no transformation is required for all except the state name to state code. The following pseudo code illustrates the mapping logic:

For (I = each requester input) {

For (j = each provider input type) {

Path = findTransformationPath (i.getType(), j);

// a path is found to transform each requester
// input to a provider input

if (path ! = null)

provider input parameter = transform(I, path);

} // all provider inputs

} // all requester inputs

It is noted that the application server's 702 input type “X.Location” is not really involved. It only serves as a guideline. It is not enforced, since the differentiating feature here is the ability to have both sides of the interface to have data that totally disagree with each other.

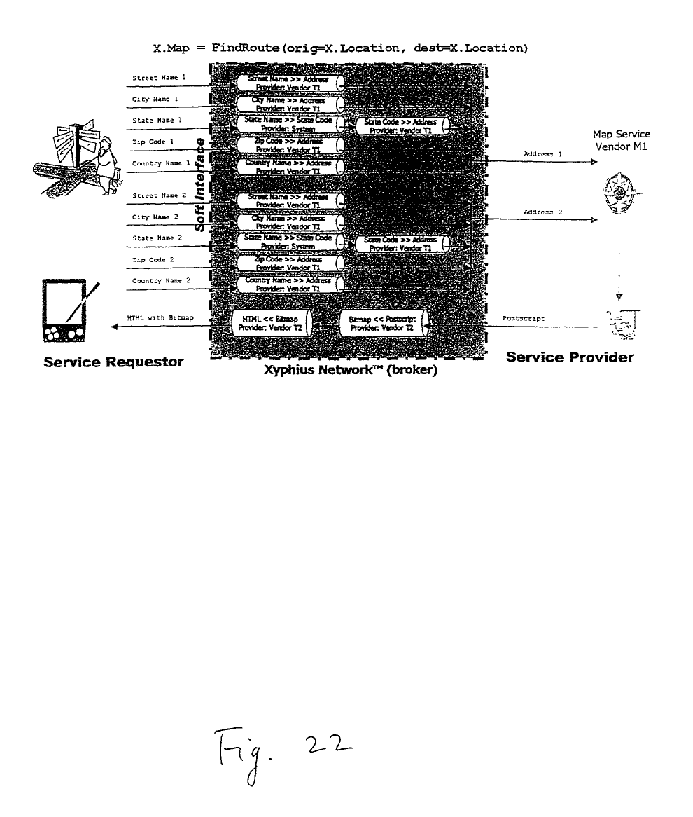

In the final M-M-M scenario, the application server 702 takes many inputs, and both the requester and the service provider's function have uneven correspondence, meaning the number of input parameters does not agree and therefore mapping is not one-to-one. FIG. 22 illustrates the many-to-many-to-many scenario. Here, the requester/end user provides two sets of the elements of two physical addresses (origination and destination addresses for plotting a course) (as concrete types). Each set of elements are associated with a single application server input label. The application server 702 determines the provider's functions (Map Service Vendor M1) to use, and then, for each set, groups the elements of the set and maps the elements of the physical address using a number of transformation functions to generate a single physical address as output for the set. The two addresses are then provided to the service provider providing the map function (shown as MAP Service Vendor M1). A map is then generated in, for example, postscript and translated to, for example, bitmap and then to, for example, HTML as specified by the requester/end user.

The algorithm to produce the mapping can be reduced to that of M-1-1 and M-1-M if each requester input parameter is associated to one and only one input defined by the application server. The following pseudo code illustrates the mapping logic:

For (s = each soft interface label) {
// for each application server label, find the provider input type

ProviderType = ProviderInputAssociatedWith(s);

// for each requester input associated with the label,
// a path is found to transform the requester input data
// to an element within the provider input data type

for (I = each requester input associated with s) {

path = findTransformationPath(i.getType(), providerType);

if (path ! = null)

provider input.add(transform(providerType, path));

// provider input is then generated from the requester's input

} // all parameters associated with application server label

} // all soft interface labels

As mentioned earlier, when executed orderly and serially, the output of the last transformation function results in the data form desired. During the execution, each transformer in the path has a provider function identified and executed. In case a failure occurs with one of the transformation providers in the path, it may be possible that the system dynamically locate the same transformation function provided by another provider.

Once the requester's data has been successfully transformed to the data format needed by the provider's function, the next step is to place the transformed data in proper containers, as required by the technology of the provider function. The function will then be located (if remotely on the application server) and invoked based on the pre-specified protocol. The following protocols supported include: URL/HTTP:Get; URL/HTTP:Put; URL/LDAP; Java Remote Messaging Interface (RMI); Jini Technology; Distributed Common Object Model (DCOM); Common Object Request Broker (CORBA); Remote Procedure Call (RPC); Remote Execution/Remote Shell (REXEC/RSH); Simple Object Access Protocol (SOAP); Java; and Pearl.

Invocation of a service provider's function may primarily be asynchronous. However, in some cases synchronous invocation may be desirable.

Once the service provider completes execution of the requested function, it is ready to return the output to the requesting party (i.e., the service requester or the end user). The application server 702 expects a single return value (i.e., second information) from the service provider, and map to a single response needed by the requester. The transformation process is similar to that of the input preparation with 1-1-1 mapping. Of course, this single value can be any concrete type that is composite in nature, i.e., can hold multiple values. The application server 702 may also support multiple outputs, and the algorithm to prepare multiple outputs is understood to those skilled in the art to be substantially similar, but in reverse direction, to that of the input preparation algorithm.

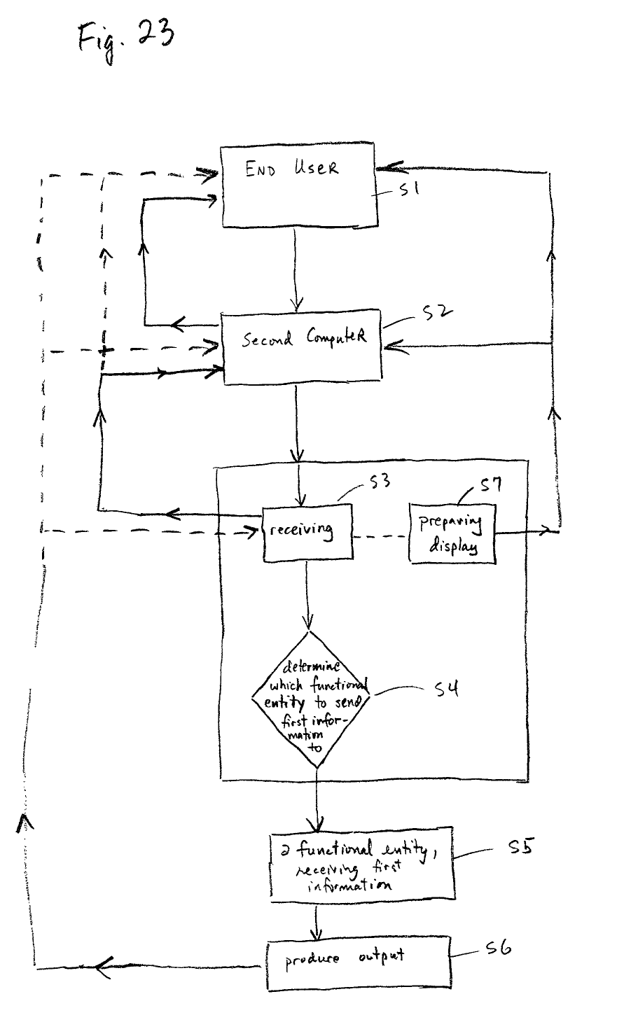

The flowchart in FIG. 23 summarizes the general processing steps of an embodiment of the present invention. At step S3, the first computer (e.g., first computer 102 and application server 702) receives first information transmitted through a network by a second computer (e.g., second computer 104 and service requester 706), at S2. At step S4, the first computer determines a functional entity (e.g., third computer 112 and service providers 714) based upon the first information, and at step S5, sends the first information to the functional entity determined at S4. The functional entity produces output at step S6 and sends the output to a recipient. If an end user is making a request for service, then the second computer receives the first information at step S1, and the second computer then transmits the first information to the first computer at step S2. The output from the functional entity at step S6 may be sent to the second computer or to the end user, if an end user is making the request.

The output from the functional entity (i.e., 112, 714) may also be sent to the first computer. For example, in the case where the first information is to be converted from a first form to another form, the functional entity determined at step S4 may be a functional entity to perform the transformation. The functional entity then produces output (e.g., converting the first information to the other form, in which case the other form is second information) at step S6 and then transmits the other form through the network to the first computer. If further transformation of the information is required, the first computer then determines at step S4 which functional entity to send the information to. If no further transformation is required, the first computer may then transmit the other form to either the second or fourth computers. If the first computer transmits the other form to the second computer, the second computer may then transmit the other form to the fourth computer (i.e., end user).

The first computer also prepares at step S7 at least one visual presentation display, which it transmits to at least one of the second computer and the fourth computer, the display including content to be displayed in at least one of a first and a second human language, and the content of the display to include a list of the functional entities. The list of the functional entities includes those that may be registered on the first computer.

The processing as described above may be performed via software, hardware, firmware, or any combination of the above. Any data handled in the processing or created as a result of the processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structure and of such data.

While the invention has been described with reference to certain illustrated embodiments, the words which have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and materials, such as are within the scope of the appended claims.

What is claimed is:

1. An apparatus comprising:
a first computer configured to communicate through a network with a second computer including a transmitting portion and a receiving portion, the first computer comprising a receiving portion, a storage portion, a processing portion, and a transmitting portion, the receiving portion to receive first information from the transmitting portion of the second computer,
the transmitting portion of the first computer being configured to transmit the first information to a functional entity based upon the first information, the functional entity configured to communicate with at least one of the first computer and the second computer 104, the functional entity comprising a receiver to receive the first information from the first computer, the functional entity to produce output based upon the first information and send the output to a recipient.

2. The apparatus of claim 1, wherein the first information is a request to perform a given task.

3. The apparatus of claim 2, wherein the functional entity comprises a functional entity capable of performing at least one task.

4. The apparatus of claim 3, wherein the at least one task includes the given task.

5. The apparatus of claim 4, wherein the processor of the first computer determines from among a plurality of functional entities a set of functional entities which can perform the given task.

6. The apparatus of claim 5, wherein the processor of the first computer is configured to determine the functional entity from the set, the first information to be communicated to the functional entity.

7. the apparatus of claim 6, wherein the receiver of the functional entity is configured to communicate with said first computer via at least one of a public switched telephone network, an Internet, and an Intranet.

8. The apparatus of claim 7, wherein the output comprises a function to be performed by the functional entity based upon the first information.

9. The apparatus of claim 8, wherein to send the output comprises delivering the output to the recipient.

10. The apparatus of claim 8, wherein the output further comprises second information.

11. The apparatus of claim 10, wherein the second information comprises a representation of a result of performing the given task.

12. The apparatus of claim 11, the functional entity further comprises a transmitter adapted to send the second information to the recipient via at least one of a public switched telephone network, an Internet, and an Intranet.

13. The apparatus of claim 12, the functional entity comprises a third computer including a receiving portion, the receiving portion being configured to receive through the network the first information from the first computer.

14. The apparatus of claim 13, wherein the third computer further comprises a processor and a transmitting portion, the processor being configured to produce the second information based on the first information, and the transmitting portion being configured to transmit through the network the second information to the recipient.

15. The apparatus of claim 14, wherein the recipient comprises at least one of the first computer and the second computer.

16. The apparatus of claim 14, further comprising a fourth computer 202 including a web browser, the fourth computer being configured to communicate through the network with the first and second computers, at least one of the receiving portion of the second computer and the receiving portion of the first computer being configured to receive the first information from the web browser of the fourth computer.

17. The apparatus of claim 16, wherein the transmitting portion of the third computer is configured to transmit the second information to the recipient, the recipient being at least one of the first computer, the third computer, and the fourth computer.

18. The apparatus of claim 1, the functional entity being configured to convert the first information comprising a first form into an other form, the other form to be transmitted by the functional entity through the network to the first computer.

19. The apparatus of claim 1, the other form to be transmitted by the first computer to at least one of the second computer and an other functional entity capable of receiving the other form.

20. The apparatus of claim 16, wherein the first computer comprises a presentation portion to prepare at least one visual presentation display to send to at least one of the second computer and the fourth computer, the display including content to be displayed in at least one of a first language and a second language, the content including a list of the plurality of functional entities.

21. The apparatus of claim 20, wherein a user of at least one of the second computer and the fourth computer is to determine the functional entity from the list.

22. The apparatus of claim 21, the display further including content to be displayed in both a first and a second language, the first and second languages to be determined by the user of the at least one of the second computer and the fourth computer.

23. The apparatus of claim 1, wherein the network comprises an Internet.

24. The apparatus of claim 1, wherein the network comprises an Intranet.

25. A method comprising:
receiving, on a first computer, first information transmitted through a network by a second computer;
determining, on the first computer, a functional entity based upon the first information,
sending the first information from the first computer to the functional entity,
the functional entity producing output based upon the first information, and sending the output to a recipient.

26. The method of claim 25, wherein the first information is a request to perform a given task.

27. The method of claim 26, wherein the functional entity is capable of performing at least one task.

28. The method of claim 27, wherein the at least one task includes the given task.

29. The method of claim 28, wherein determining the functional entity comprises determining from among a plurality of functional entities a set of functional entities which can perform the given task.

30. The method of claim 29, wherein determining the functional entity further comprises determining the functional entity from the set.

31. The method of claim 30, wherein sending the first information comprises transmitting the first information to a receiver of the functional entity, the receiver configured to communicate with the first computer via at least one of a public switched telephone network, an Internet, and an Intranet.

32. The method of claim 31, wherein producing output comprises performing a function based upon the first information.

33. The method of claim 32, wherein producing output further comprises second information.

34. The method of claim 33, wherein the second information comprises a representation of a result of performing the given task.

35. The method of claim 34, wherein sending the output to a recipient comprises transmitting the second information to the recipient via at least one of a public switched telephone network, an Internet, and an Intranet.

36. The method of claim 34, wherein the functional entity comprises a third computer including a receiving portion, the receiving portion being configured to receive through the network the first information.

37. The method of claim 34, wherein the third computer further comprises a processor configured to perform a function and a transmitter, the processor producing the second information based upon the first information, the transmitter transmitting through the network the second information to the recipient.

38. The method of claim 37, wherein the recipient comprises at least one of the first computer and the second computer.

39. The method of claim 37, further comprising receiving, on the second computer, the first information transmitted through a network from a fourth computer.

40. The method of claim 39, wherein the recipient comprises at least one of the first computer, the second computer, and the fourth computer.

41. The method of claim 37, further the functional entity converting the first information comprising a first form into an other form, and transmitting the other form through the network to the first computer.

42. The method of claim 41, further comprising transmitting the other form to at least one of the second computer and an other functional entity capable of receiving the other form.

43. The method of claim 37, further comprising preparing, in the first computer, at least one visual presentation display to transmit to at least one of the second computer and the fourth computer, the display including content to be displayed in at least one of a first language and a second language, the content including a list of the plurality of functional entities.

44. The method of claim 43, further comprising a user of at least one of the second computer and fourth computer determining the functional entity from the list.

45. The method of claim 19, further comprising a user of the at least one of the second computer and the fourth computer determining the at least one of the first and second languages to be displayed.

46. A computer-readable medium encoded with a program for a computer, the program comprising:
receiving, on a first computer, first information transmitted through a network by a second computer,
determining, on the first computer, a functional entity based upon the first information,
sending the first information from the first computer to the functional entity, the functional entity producing output based upon the first information and sending the output to a recipient.

47. The computer-readable medium of claim 46, wherein the first information is a request to perform a given task.

48. The computer-readable medium of claim 47, wherein the functional entity is capable of performing at least one task.

49. The computer-readable medium of claim 48, wherein the at least one task includes the given task.

50. The computer-readable medium of claim 49, wherein the program further comprises determining the functional entity comprises determining from among a plurality of functional entities a set of functional entities which can perform the given task.

51. The computer-readable medium of claim 50, wherein determining the functional entity further comprises the program determining the functional entity from the set.

52. The computer-readable medium of claim 51, wherein sending the first information comprises transmitting the first information to a receiver of the functional entity, the receiver configured to communicate with the first computer via at least one of a public switched telephone network, an Internet, and an Intranet.

53. The computer-readable medium of claim 52, wherein producing output comprises performing a function based upon the first information.

54. The computer-readable medium of claim 53, wherein producing output further comprises second information.

55. The computer-readable medium of claim 54, wherein the second information comprises a representation of a result of performing the given task.

56. The computer-readable medium of claim 55, wherein sending the output to a recipient comprises transmitting the second information to the recipient via at least one of a public switched telephone network, an Internet, and an Intranet.

57. The computer-readable medium of claim 55, wherein the functional entity comprises a third computer including a receiving portion, the receiving portion being configured to receive through the network the first information.

58. The computer-readable medium of claim 55, wherein the third computer further comprises a processor configured to perform a function and a transmitter, the processor producing the second information based upon the first information, the transmitter transmitting through the network the second information to the recipient.

59. The computer-readable medium of claim 58, wherein the recipient comprises at least one of the first computer and the second computer.

60. The computer-readable medium of claim 58, further comprising receiving, on the second computer, the first information transmitted through a network from a fourth computer.

61. The computer-readable medium of claim 60, wherein the recipient comprises at least one of the first computer, the second computer, and the fourth computer.

62. The computer-readable medium of claim 58, further comprising the functional entity converting the first information comprising a first form into an other form, and transmitting the other form through the network to the first computer.

63. The computer-readable medium of claim 62, further comprising transmitting the other form to at least one of the second computer and an other functional entity capable of receiving the other form.

64. The computer-readable medium of claim 58, further comprising preparing, in the first computer, at least one visual presentation display to transmit to at least one of the second computer and the fourth computer, the display including content to be displayed in at least one of a first language and a second language, the content including a list of the plurality of functional entities.

65. The computer-readable medium of claim 64, further comprising a user of at least one of the second computer and fourth computer determining the functional entity from the list.

66. The computer-readable medium of claim 64, further comprising a user of the at least one of the second computer and the fourth computer determining the at least one of the first and second languages to be displayed.
